(19) United States
(12) Patent Application Publication
(10) Pub. No.: US 2004/0259527 A1
(43) Pub. Date: Dec. 23, 2004

(54) Method of connecting to a data or tele net with a subscription that includes at least two different payment categories

(76) Inventor: Mats Lindberg, Nynashamn (SE)

Correspondence Address: BIRCH STEWART KOLASCH & BIRCH, PO BOX 747, FALLS CHURCH, VA, 22040-0747, US

(21) Appl. No.: 10/486,518

(22) PCT Filed: Aug. 13, 2002
(86) PCT No.: PCT/SE02/01449

(30) Foreign Application Priority Data
Aug. 14, 2001 (SE) 0102709-3

(51) Int. Cl. H04M 11/00

(52) U.S. Cl. 455/406

(57) ABSTRACT

The invention relates to a method of coupling to a data network or to a telecommunications network for transmitting and/or receiving information, such as a mobile telephone call, wherein a connected apparatus is associated with a subscription that includes a catalogue number. The invention is characterised in that said subscription includes at least two different payment categories that are each associated with the same or different forms of payment and payment liability, wherein said form of payment are chosen between a prepayment mode or a billing credit mode, wherein the payment liable person is a legal person or a physical person, and wherein the subscription is caused to switch the payment category during an ongoing call without breaking or releasing the connection, owing to the fulfilment of at least one switching condition regarding payment category in respect of the subscription.

The present invention relates to a method of connecting to a data network or to a telecommunications network.

The use of telephones normally entails telephone subscriptions with which the user is given a unique catalogue number from the telephone network operator. When the user calls another user who has a subscription with the same telephone operator as said user or a subscription with some other telephone operator, a special account tied to the used subscription is billed.

The account may be a prepaid account or may have been given a certain amount of credit, wherewith payment is made later in response to a bill or invoice. In the former case, the subscription will continue only until the sum prepaid into the account has been used up, whereupon the telephone connection is released and a new connection cannot be established until the prepaid account has been topped up. In the latter case, there is normally no restriction to the call time of the subscription.

It is often undesirable for a call time to be restricted in the same way as that occasioned by a prepaid account. Because different call tariffs often apply at different times of the day, and so on, it may be difficult to assess correctly the call time that remains on the account. This means that the user cannot feel sure that the account contains sufficient funds for calling to the extent desired on all occasions.

This is a particular problem with regard to so-called company subscriptions where a company pays for an employee's mobile telephone subscription, so that the employee will be able to use his/her telephone to the extent required in carrying out his/her work.

There is known to the art a method in which a certain amount of credit is given to enable a call connection to be maintained in the event of such a subscriber account running out of funds. This credit, however, is limited to a given sum and the connection is definitely released when this greater sum has been reached.

An alternative to the prepaid account is a subscription in which the cost of calls is billed subsequently by invoice. This avoids the company problem where a call connection is released abruptly because there is no money left in the account.

On the other hand, another problem arises in this case when the company reports the costs entailed. When a prepaid account is used together with an employee's mobile telephone subscription, it is easy to allocate to each employee a limited amount for which he/she is able to call. In this case, it is a simple matter to control the amount to be paid to the mobile telephone operator.

When, on the other hand, there is used a subscription where the account is subsequently settled upon receipt of a bill or invoice, the company is not able to control the amount of money entailed monthly by an employee with the same ease as in the former case.

The present invention solves these problems associated with company mobile telephone subscriptions. It will be understood, however, that the invention can also be used to solve corresponding problems in respect of subscriber connections to any data network or telecommunications network whatsoever for transmitting and/or receiving information, such as, e.g., in the case of a fixed telephone network or in respect of subscriptions for connecting modems to the Internet.

The present invention thus relates to a method of connecting to a data network or a telecommunications network for the transmission and/or reception of information, such as a mobile telephone call, where a connected apparatus is associated with a subscription that includes a catalogue number, and where the method is characterised by said subscription including at least two mutually different payment categories that are each associated with one and the same or with different payment forms and payment liabilities, wherein said payment forms are chosen between a prepayment or a billing credit, and wherein said payment liability relates to a given legal person or corporate body or a physical person, and wherein the subscription is caused to switch between payment categories during an ongoing call connection without releasing said connection, owing to the fulfilment of at least one switching condition concerning payment category in respect of the subscription.

The invention thus relates to any connection to any data network or telecommunications network whatsoever where the connection is effected with the aid of a connecting device within the framework of a subscription. Such a subscription is normally associated with a catalogue number, in the case of telephony a so-called telephone number. The catalogue number may alternatively be of a different type, for instance an IP address in the case of Internet communication.

According to the invention, the aforesaid subscription further includes at least two payment categories. A payment category is defined by a form of payment on the one hand and a payment liability on the other hand.

The expression “form of payment” applies to how payment of a call shall take place in accordance with a given payment category. According to the invention, payment is effected in one of two ways. According to a first way of payment, the person liable for payment of the subscription has previously paid in a sum of money for which calls can be made as long as the prepaid amount does not run out. The second way of making payment includes, instead, a credit account which is billed later by issuing an invoice, for instance monthly.

The phrase “person liable for payment” applies to the person who carries the responsibility for payment of calls connected within the framework of the subscription with the aid of a connecting apparatus, such as a telephone or a computer. The “person liable for payment” may be any person whatsoever, both a physical person and a legal person. It will be noted that the person liable for payment need not necessarily be the same person as that who connects to the network within the framework of the subscription.

Thus, a “payment category” is a combination of a form of payment and a person liable for payment, which together define how the operator can expect to receive payment for connection services. The magnitude of the payment can conceivably be based on the connection time, the time of day when the connection was made and/or other calculating methods.

A subscription thus comprises at least two such payment categories, so that a category shift can be readily made between the manner in which payment for the connection shall be made.

By “switching conditions” is meant a condition which when fulfilled causes the subscription to switch a payment category from one such category that is included in the subscription to another category. One such condition may, for instance, cause a switch to be made when the amount prepaid to an account has run out, when it has been possible to bill a given sum to a credit account, when a given period of time has passed or any other condition whatsoever whose outcome can be derived from the data included in the subscription.

It is desirable that switching can be effected between two different payment categories within the framework of the subscription when a switching condition is fulfilled, without the connection being released, broken or disturbed in some other way. According to one preferred general embodiment, the same catalogue number is used both prior to and subsequent to shifting payment category, to this end. For instance, in the case of a typical stationary or mobile telephony, this means that all payment categories are normally associated with one and the same catalogue number within the framework of a subscription. In the case of certain applications, for instance Internet communication, it is conceivable to change the catalogue number more or less often, as a result of the way in which the communication is arranged from a purely technical aspect. On the other hand, the catalogue number is not changed as an immediate result of changing the payment category.

According to one preferred general embodiment, the category switching conditions associated with the subscription are tied to the amount of money that has been used during the connection with the subscription. In this case, the subscriber is billed on a time basis, for instance with a given sum for each call minute.

According to another preferred general embodiment, the category switching conditions are also of a maximum nature, by which is meant that said conditions include a given upper limit with respect to the sum that the user can spend in accordance with the tariff for establishing a connection within the framework of the subscription, for the period of time that the user may establish a connection within the framework of the subscription, or some other condition of a maximum nature. When the limit is reached, the subscription consequently switches the form of payment.

According to another preferred general embodiment, the subscription includes two different payment categories.

According to one highly preferred general embodiment, only one such maximising switching condition is associated with a subscription. This embodiment means that the user uses the subscription as follows: Initially, connection with the subscription takes place with debiting on a time basis in accordance with a determined payment category. Subsequent to having reached a given billing sum, the subscription automatically switches to the other payment category in accordance with the category switching condition, without the call being released or disturbed in any other way. The subscription uses the same catalogue number during the entire process.

A number of preferred exemplifying embodiments will now be described. These embodiments shall be seen as typical methods of carrying out the present invention and do not constitute any limitation of the invention. All examples include the use of mobile telephone units for connecting to the network of a mobile telephone operator. The connection takes place within the framework of the subscription in accordance with the invention.

According to a first exemplifying embodiment, a company obtains a mobile subscription from an operator for each of its employees. Each such subscription includes two payment categories, namely a) a category in which payment is a prepaid payment and the company is responsible for payment being made; and b) a category in which the form of payment is a billing or invoice credit and the employee is responsible for payment being made. The subscription also includes a category switching condition in the form of a maximum amount with respect to billing for a connection made with the aid of the subscription, with which fulfilment of a condition the payment category is caused to be switched from category a) above to category b) above.

Thus, when the employees call on their mobile telephones, the prepaid sum is initially billed to the company. This sum, or amount, is determined by the company and may differ with different employees. When this first amount has been used up, the category switching condition comes into being and causes the subscription to switch the payment category to the other payment category. The call is not broken, but instead of debiting the prepaid account, payment for the connection service in respect of the excess amount is now billed with the aid of an invoice which is sent directly to the employee at a later time.

For example, such a subscription can be arranged to be billed monthly, i.e. the company pays in advance a given sum per employee to the mobile operator, who then sends monthly an invoice for the amount that has been incurred by the employee's calls over and above the prepaid amount.

The prepaid amount may also be drawn from a bank account, or in accordance with some comparable arrangement, into which money has earlier been lodged by the company.

According to a second exemplifying embodiment of the invention, which is the same as the aforedescribed first exemplifying embodiment but with the difference that instead of the payment form in the second payment category being a billing or invoice credit, it is now a prepaid payment. This means that when the initially prepaid sum has been used up, the subscription shifts to debit another prepaid account. The employee is personally responsible for this latter account.

The prepaid accounts may well be a bank account or some similar account also in this case.

According to a third exemplifying embodiment of the invention, which is the same as the aforedescribed first exemplifying embodiment but with the difference that instead of the payment form in the first payment category being a prepaid form, it is now in the form of a billing or invoice credit. It will be noted that despite the company not having prepaid a given amount of money, the category switching condition still applies. In other words, when the employee has called for a given sum, the payment category switches from the first category to the second category despite the fact that there may still be money in the account that the company has placed at the disposal for billing purposes with respect to the mobile telephone operator.

According to a fourth exemplifying embodiment which is the same as the aforedescribed first exemplifying embodiment but with the difference that instead of the form of payment in the first payment category being a prepaid form, it is now in the form of a billing credit and that instead of the form of payment in the second payment category being a billing credit, it is now in a prepayment form.

Although the invention has been described above with reference to a relationship between a person and a company, it will be understood that the invention can be applied with other constellations, such as within a family where different family members have different accessibility and therefore adapted switching conditions.

The present invention shall not be considered to be limited- to the aforedescribed exemplifying embodiments thereof, since variations can be made within the scope of the accompanying claims.

1. A method of coupling to a data network or to a telecommunications network for transmitting and/or receiving information, such as a mobile telephone call, wherein a connected apparatus is associated with a subscription that includes a catalogue number, characterised in that said subscription includes at least two different payment categories that are each associated with the same or different forms of payment and payment liability, wherein said forms of payment are chosen between a prepayment mode or a billing credit mode, wherein the payment liable person is a legal person or a physical person, and wherein the subscription is caused to switch payment category during an ongoing call without breaking or releasing the connection, owing to the fulfilment of at least one switching condition regarding payment category in respect of the subscription.

2. A method according to claim 1, characterised in that the same catalogue number is used both before and after switching between all payment categories within the framework of one and the same subscription.

3. A method according to claim 2, characterised in that the switching conditions of the subscription are tied to the sum of money that has been used during the connection with the subscription.

4. A method according to claim 3, characterised in that the switching conditions of the subscription include a given upper limit with respect to the sum used.

5. A method according to claim 4, characterised in that the subscription has only one such switching condition.

6. A method according to claim 5, characterised in that the subscription includes two different payment categories, of which one is associated with the prepayment form of payment and a payment liability that rests on a company, and the second category is associated with a billing credit payment form and a payment liability that rests on a given person employed by the company.

7. A method according to claim 5, characterised in that the subscription includes two different payment categories, of which one is associated with the prepayment form of payment and a payment liability that rests on a company, and the other category is associated with a prepayment form of payment and a payment liability that rests on an employee of the company.

8. A method according to claim 5, characterised in that the subscription includes two different payment categories, of which one is associated with the billing credit form of payment and a payment liability that rests on a company, and the other category is associated with a billing credit payment form and a payment liability that rests on an employee of the company.

9. A method according to claim 5, characterised in that the subscription includes two different payment categories, of which one is associated with the billing credit form of payment and a payment liability that rests on a company, and the other category is associated with the prepayment form of payment and a payment liability that rests on an employee of the company.
